(19) United States
(12) Patent Application Publication
(10) Pub. No.: US 2022/0396378 A1
(43) Pub. Date: Dec. 15, 2022

(54) SPACE HABITAT CORE

(71) Applicant: Sierra Space Corporation, Broomfield, CO (US)

(72) Inventors: Charles John Hatsell, Thornton, CO (US); Loren T. McDaniel, Denver, CO (US); Eric Charles Schleicher, Wheat Ridge, CO (US); Grant Robert Woods, Littleton, CO (US)

(21) Appl. No.: 17/718,004

(22) Filed: Apr. 11, 2022

Related U.S. Application Data
(60) Provisional application No. 63/209,354, filed on Jun. 10, 2021.

(51) Int. Cl. B64G 1/48; B64G 99/00

(52) U.S. Cl. CPC B64G 1/48; B64G 9/00

(57) ABSTRACT

Methods, devices, and systems are described for a core of a space habitat. The core includes a plurality of internal beams extending a length of the core. The core also includes a plurality of end rings at a first end of the core and a second end of the core, the plurality of end rings spaced the length of the core. The core also includes an internal ring coupled to the internal beams between the first end and the second end.

### CROSS-REFERENCE TO RELATED APPLICATIONS

This application claims priority to U.S. Provisional Application No. 63/209,354 entitled “SPACE HABITAT CORE” and filed on Jun. 10, 2021, the disclosure of which is incorporated herein by reference in its entirety.

### STATEMENT OF GOVERNMENT SPONSORED SUPPORT

Certain aspects of the subject matter described herein were developed with U.S. Government support under Contract No. 80HQTR17C0009 awarded by NASA. The U.S. Government has certain rights in the invention.

### TECHNICAL FIELD

The present disclosure relates generally to space structures, and more particularly, to a space habitat core.

### BACKGROUND

Space habitats are needed to support mission activities in space. A space habitat may be formed from a core and a bladder surrounding the core. The bladder and a soft goods layer may be stowed uninflated around the core within a launch vehicle. Once in space, the space habitat may inflate and become pressurized to support mission activities in space. The core may be stressed by the pressurization of the bladder and soft goods around the core. This pressurization may compromise the structural integrity of the core, potentially causing the core to bend or create an air leak. Further, the core must also support various mission activities both prior to launch and following launch that require the transportation of cargo and personnel.

### SUMMARY

The present disclosure provides methods, devices, systems, and articles of manufacture for a space habitat core.

In one aspect, there is provided a device for a core of a space habitat. The core comprises a plurality of internal beams extending a length of the core. The core also includes a plurality of end rings at a first end of the core and a second end of the core, the plurality of end rings spaced the length of the core. The core also comprises an internal ring coupled to the internal beams between the first end and the second end.

In some variations, the core further comprises a plurality of modular laminate skins configured to couple to the plurality of internal beams, the plurality of end rings, and the internal ring, wherein the plurality of modular laminate skins, the plurality of internal beams, the plurality of end rings, and the internal ring form an outer shell of the core. Further, the at least one modular laminate skin of the plurality of modular laminate skins has a cutout, and wherein the plurality of modular laminate skins is fastened to at least one of the plurality of internal beams, the internal ring, and the plurality of end rings. In some variations, the cutout is sized to support a passage of humans and cargo through the space habitat.

Further, the core further comprises a plurality of modular shear panels configured to mount to the internal beams, wherein the plurality of modular shear panels may be adjacent to one end ring of the plurality of end rings in a pre-launch configuration. Additionally, the plurality of modular shear panels includes a lip, the lip configured to overlap an internal beam of the plurality of internal beams for supporting the plurality of modular shear panels. In some variations, the core further comprises a mounting track extending the length of the core along a first internal beam of the plurality of internal beams, wherein the mounting track includes a bar with an aperture. Additionally, the aperture is configured to receive a wheel from a device configured to slide along the mounting track. Further, the aperture includes recesses aligned along both sides of the mounting track, the recesses configured to enable a device configured to slide along the mounting track to lock in place.

In another aspect, there is provided a method for reconfiguring shear panels in a space habitat. The method comprises securing the shear panels near an end ring of a core prior to a launch of the space habitat, the shear panels being interposed between a plurality of internal beams extending from the end ring. The method also comprises securing the shear panels along a different portion of the core based on launching the space habitat.

In some variations, the different portion includes a corridor extending a length of the core. Further, the shear panels are placed proximate to the end ring of the core to prevent buckling of the core due to compressive forces from a bladder and a soft goods layer wrapped around the core. Additionally, the different portion includes at least one of a work surface or a partition located inside the space habitat.

In yet another aspect, there is provided a space habitat system. The space habitat system comprises a core for a space habitat, and a vestibule coupled to a first end of the core, the vestibule forming a volume of the space habitat. The space habitat system also comprises a pressurization bulkhead coupled to a second end of the core, the pressurization bulkhead being a rigid structure configured to take a pressure load.

In some variations, the vestibule includes an airlock with a pressure barrier between the core and the vestibule. In some variations, the vestibule includes an interface for docking to an external spacecraft. In some variations, the vestibule is coupled to a robotic arm that manipulates objects in space. In some variations, the pressure bulkhead is further configured to be a payload adapter.

In some variations, the core further comprises a plurality of internal beams extending a length of the core, a plurality of end rings at the first end of the core and the second end of the core, the plurality of end rings spaced the length of the core; and an internal ring coupled to the internal beams between the first end and the second end. In some variations, the core further comprises a plurality of modular laminate skins configured to couple to the plurality of internal beams, the plurality of end rings, and the internal ring, wherein the plurality of modular laminate skins, the plurality of internal beams, the plurality of end rings, and the internal ring form an outer shell of the core.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes, it should be readily understood that such features are not intended to be limiting. The claims that follow this disclosure are intended to define the scope of the protected subject matter.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1A depicts an example of a diagram representative of a cross-section of a space habitat having a core and bladder;

FIG. 1B depicts an example of a diagram representative of a space habitat including a core attached to a vestibule and a bladder covered with a soft goods layer and a debris shield;

FIG. 2 depicts an example of a diagram representative of a core of a space habitat;

FIG. 3 depicts an example of a diagram representative of a laminate skin for the core of the space habitat;

FIG. 4 depicts an example of a diagram representative of a shear panel for the core of a space habitat;

FIG. 5 depicts an example of a diagram representative of a cross-section of a core configuration within the space habitat;

FIG. 6 depicts another example of a diagram representative of another cross-section of a core configuration within the space habitat having a corridor and a table;

FIG. 7 depicts an example of a diagram representative of a core configuration within the space habitat with two floors;

FIG. 8 depicts another example of a diagram representative of a mounting track extending along an internal beam of the core;

FIG. 9 depicts an example of a diagram representative of a core with a vestibule and a pressure bulkhead assembly; and

FIG. 10 depicts an example of a diagram representative of a core attached to an external space structure.

### DETAILED DESCRIPTION

The space habitat may be formed from a core and a bladder surrounding the core. Together, the core and bladder may provide a habitat for humans that shelters against space debris and radiation while maintaining a habitable air-breathing environment. A soft goods layer, such as a webbing, may cover the bladder for protection and to increase the likelihood of an even weight distribution across the bladder. The soft goods layer may include a webbing of straps in a basket-weave configuration to maintain the shape of the bladder and to prevent straining of the bladder. But the combination of the soft goods layer and the bladder may place significant strain on the core.

The design of the core may serve multiple critical purposes in pre-launch and post-launch. Before launch and prior to expanding the bladder, the bladder and soft goods may be wrapped around the core. The core may buckle from significant pushing strain from the bladder and soft goods being compressed around the core. After launch and after expanding the bladder, the core may have structural failure from significant pulling strain from the bladder and the soft goods at the endpoints of the core. This pulling strain may increase as the bladder is pressurized. Additionally, the core may enable mission activities that require the entry and exit of cargo and personnel. The strain on the core may cause air leaks near the core and the buckling of the core. A strong core during pre-launch and post-launch may be necessary to maintain a safe pressurized space habitat. Additionally, a strong core may enable transportation of cargo in, out, and within the space habitat.

The core here may solve the problem of the core structure becoming compromised from the pushing and pulling strains of the bladder and the soft goods through the combination of end rings, internal beams, and internal rings. The core may also support the transportation of cargo and personnel within the core. Since the core may be integrated into a space habitat, the core may be designed not only for successful deployment of the habitat but also for the transportation of personnel and cargo to different portions of the space habitat. The core here may also prevent safety concerns related to air leaks at or near the core-bladder interface. Additionally, the core components may be configured to transport cargo in, out, and through the space habitat. The core here may maintain a safe pressurized space habitat while allowing for the transportation of cargo in, out, and within the space habitat as needed.

The core may include an arrangement of internal beams, internal rings, and end rings. The core may provide the structural support necessary to prevent the core from buckling under significant pressure prior to launch and after launch. The arrangement may accommodate the transportation of cargo and personnel throughout the core. For example, the core may utilize modular laminate skins with cutouts to facilitate the movement of cargo throughout the core. The cutouts of the laminate skins may provide space through which objects may be manipulated. The laminate skins may fasten to the internal beams, internal rings, and end rings of the core. Additionally, modular panels may be configured together to create pathways, work surfaces, and partitions within the core. Prior to launch, the modular panels may reinforce the structural integrity of the core. The core also may have the structural integrity for large apertures at both ends of the core. These apertures may support the passing of humans and cargo but also the connecting of the habitat to other spacecraft or space stations.

The methods, systems, and apparatuses described herein are for a core to maintain a safe pressurized space habitat while allowing for the transportation of cargo in, out, and within the space habitat as needed. The various embodiments also maximize the functionality of the core prior to launch and following the launch.

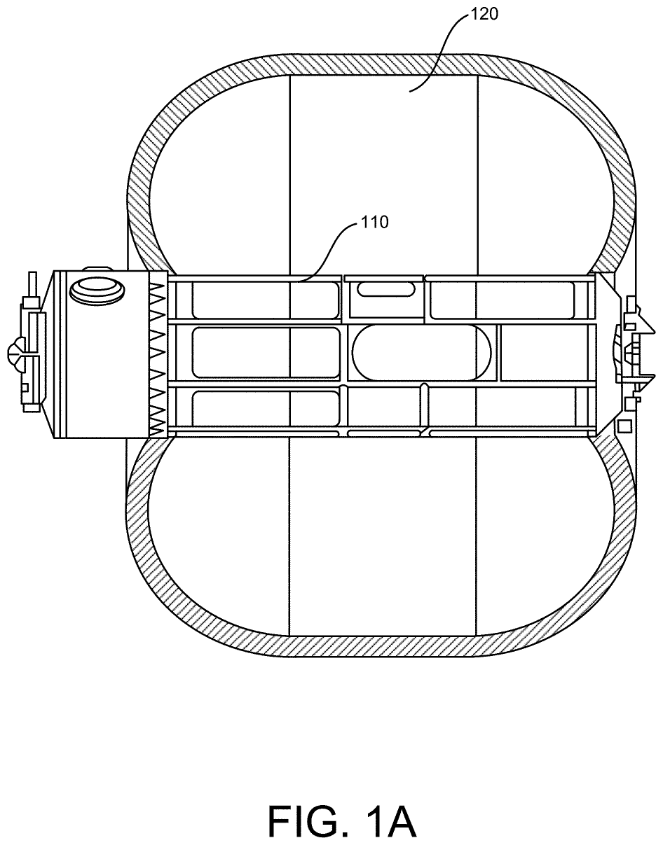

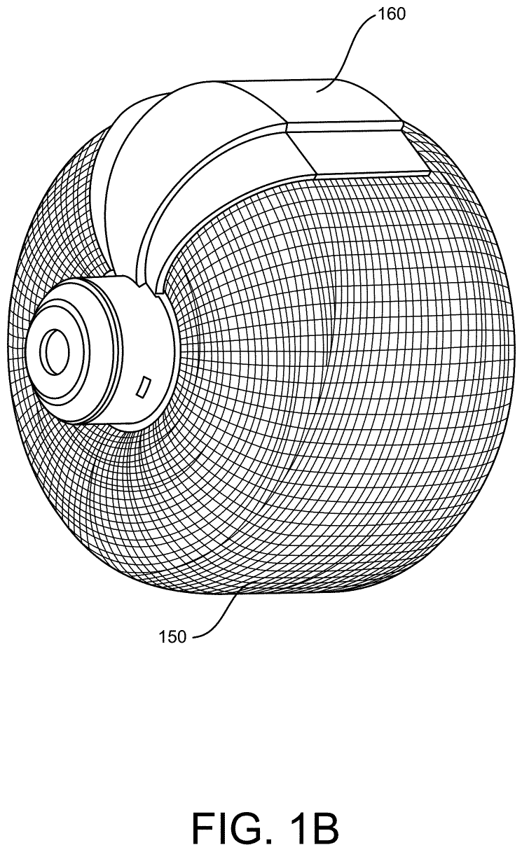

FIG. 1A depicts an example of a diagram representative of a cross-section of a space habitat having a core and bladder. The space habitat may be formed from a core 110 and a bladder 120 coupled to the core 110. The bladder 120 may connect to the far ends of the core 110 such as at opposed ends or opposed regions of the core. The bladder 120 may expand out from the core 110 when pressurized. The bladder 120 may have a toroid shape about the core 110 in a non-limiting example.

The core 110 may be a rigid frame for the space habitat. The core 110 may have a cylindrical shape with a hollow interior. The hollow interior may allow cargo and persons to pass from one end of the core 110 to the other end of the core 110. The core 110 may include openings at the far ends of the core 110. The openings may allow the space habitat to interface with other space structures to receive cargo or personnel. For example, the core 110 may be attached to a vestibule for receiving cargo. In another example, the core 110 may include a pressurization cap to maintain the pressure inside of the core 110.

The bladder 120 may be connected to the ends of the cylindrical core 110. The bladder 120 may be stored uninflated at the core 110 to minimize its footprint prior to launch. Following launch, the bladder 120 may inflate under pressure. The pressurized bladder 120 may support human activity in space. The bladder 120 may be stressed by the pressurization, which potentially poses significant safety concerns to inhabitants and equipment. For example, an air leak may result at the interface between the core 110 and the bladder 120. In another example, flooring, paneling, partitions, equipment racks, and cargo nets may need to be connected to the bladder 120, potentially causing uneven stress distribution across the bladder 120.

With reference still to FIG. 1A, the bladder 120 may be a component for retaining gas. The bladder 120 may create an air-tight seal for the space habitat. The bladder 120 may have a low gas permeability. The bladder 120 may maintain pressurized air inside the habitat to support human life. The bladder 120 may be symmetrical about the core 110. For example, the bladder 120 may retain a toroid shape about the core 110. In another example, the bladder 120 may have a spherical shape about the core 110. In some embodiments, the bladder 120 may bulge outward at the area proximate to the core 110. In some embodiments, the bladder 120 may have the shape of a wheel at the portion furthest from the core 110.

The bladder 120 may be pressurized to fill a soft goods layer 150. The soft goods layer 150 may be a restraint on the shape and size of the bladder 120. For example, the bladder 120 may be pressurized to fill the contours of an axial and hoop webbing restraint. The bladder 120 may be slightly oversized relative to the soft goods layer 150 to prevent overinflating. The bladder 120 may elongate to increase the likelihood that the bladder 120 reaches the constraining contours of the axial and hoop webbing restraints.

FIG. 1B depicts an example of a diagram representative of a space habitat including a core 110 attached to a vestibule and a bladder 120 covered with a soft goods layer 150 and a debris shield 160. The soft goods layer 150 may cover the bladder 120 and be interposed between the debris shield 160 and the bladder 120.

The soft goods layer 150 may be wrapped around the bladder 120. The soft goods layer 150 may comprise an axial and hoop webbing. The axial and hoop webbing may reinforce the bladder 120 and prevent uneven stress distribution across the bladder 120. The axial and hoop webbing may be configured to increase the likelihood that the bladder 120 retains its shape. The axial and hoop webbing may be woven together to create an even stress distribution across the bladder 120. For example, the axial webbing may alternate between going over and under the hoop webbings. Additionally, and/or alternatively, the hoop webbing may alternate between going over and under the axial webbings. Various weave patterns may be created between the axial and hoop webbings. The axial and hoop webbing may be spaced around the circumference of the bladder 120. The axial and hoop webbing may be made of Vectran. A hoop strap may be joined to the axial strap with a stitching, an adhesive, and/or the like. Similarly, the axial strap may be joined to the hoop strap with a stitching, an adhesive, and/or the like.

The debris shield 160 may be wrapped around the axial and hoop webbing. The debris shield 160 may protect the bladder 120 and axial and hoop webbing from debris in space. The debris shield 160 may be made from multiple layers of foam, insulation, and other materials. A vestibule may be connected to either side of the core 110. The vestibule may be an interface for connecting to an external space structure. The vestibule may be a transition chamber between the space habitat and the external space structure. Either side of the vestibule may include a selectively removable air pressure door configured to seal off pressure between the vestibule and the external spacecraft.

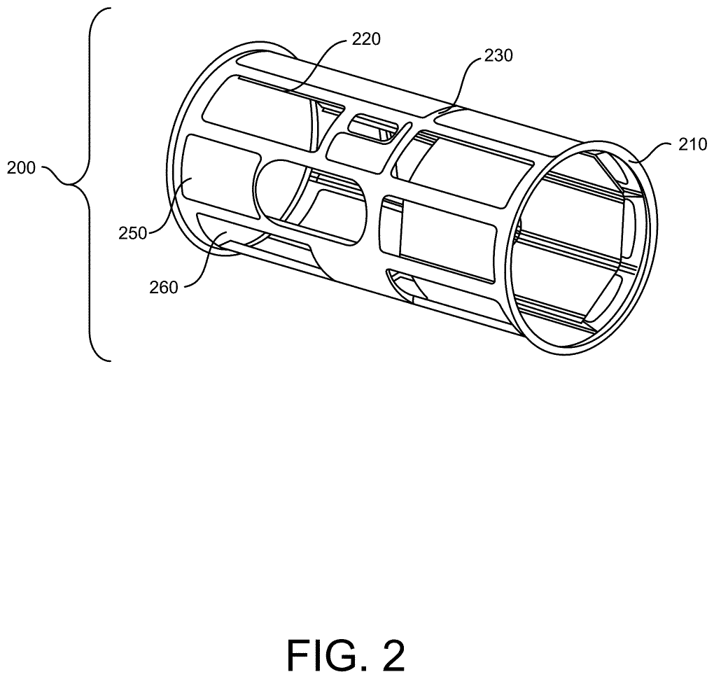

FIG. 2 depicts an example of a diagram representative of a core 200 of a space habitat. The space habitat may have a pre-launch configuration for the core 200 and a post-launch configuration for the core 200. Prior to launch, the core 200 may have the bladder and the soft goods wrapped around the core 200. The bladder and soft goods wrapped around the core 200 may create a compressive force around the core 200. For example, the core 200 may buckle from pushing strain from the bladder, the soft goods, launch loads, and a possible vehicle load being compressed around the core 200. After launch and after expanding the bladder, the core 200 may have structural failure from significant pulling strain from the bladder and the soft goods at the endpoints of the core 200. This pulling strain may increase as the bladder is pressurized. Additionally, the core 200 may enable mission activities that require the entry and exit of cargo and personnel. The strain on the core 200 may cause air leaks near the core 200 and the buckling of the core 200. A strong core during pre-launch and post-launch may be necessary to maintain a safe pressurized space habitat. Additionally, a strong core may enable transportation of cargo in, out, and within the space habitat. The core 110 may store items during launch.

The core 200 may include end rings 210 positioned at or near opposed ends of the core 200. The end rings 210 may be circular and may be forged of steel, titanium, aluminum, or a steel alloy. The end rings 210 may be placed at each end of the core 200. The end rings 210 may be hollow for receiving cargo and personnel. The end rings 210 may be configured to interface with a vestibule and a pressurization bulkhead. The end rings 210 may be configured to dock to external space structures. The end ring may include a lip extending around the edge of the ring. The lip may enable a bracket to clamp to the edge of the end ring. The bracket may be connected to the soft goods layer. Additionally, and/or alternatively, the bracket may be connected to the bladder extending around the core 200. The lip of the end rings 210 may flare outwards away from the exterior portion of the end rings 210. The end rings 210 may include two or rings assembled together to reinforce the structural integrity of the end rings 210. The end ring may have a diameter of eight feet.

The core 200 may include internal beams 220. The internal beams 220 may extend the entire length or partial length of the core 200. The internal beams 220 may connect the end rings 210 together. The internal beams 220 may extend in a direction approximately perpendicular to the orientation of the end rings 210. The internal beams 220 may be mounted to an inside edge of the end rings 210. The internal beams 220 may be evenly spaced from one another around the edge of the end rings 210. In at least one embodiment, eight internal beams 220 may be situated between the end rings 210. Each of the eight internal beams 220 may be evenly spaced from one another. Each of the eight internal beams 220 may fasten to the end rings 210. Additionally, and/or alternatively, each of the eight internal beams 220 may be fastened or assembled to the end rings 210. The ends of the internal beams 220 may be approximately perpendicular to the edge of the end rings 210. The internal beams 220 may be an I-beam shape.

The core 200 may include internal rings 230. The internal rings 230 may be circular in shape and may be made of graphite laminate, steel, titanium, aluminum, an aluminum composite, or a steel alloy. The internal rings 230 may be situated between the end rings 210. The internal rings 230 may be hollow for receiving cargo and personnel within the core 200. The internal rings 230 may be configured to connect to the internal beams 220. The internal rings 230 may run parallel to the end rings 210 and prevent the buckling of the core 200 by wrapping around the internal beams 220 at various points between the end rings 210. For example, the internal rings 230 may connect to the eight internal beams 220 along the same cross-section in the core 200. Connecting the internal rings 230 along the same plane or cross-section in the core 200 may prevent buckling of the core 200. The internal rings 230 may be assembled to each of the internal beams 220 of the core 200. The internal rings 230 may include cutouts for interfacing with each of the internal beams 220. The core 200 may include at least two internal rings between the end rings 210. In some embodiments, the internal rings 230 may be slanted at an angle between the internal beams 220. The internal rings 230 may be flush with the outer edge of the internal beams 220 such that the outer edge of the internal beams 220 are aligned with the internal rings 230.

With reference still to FIG. 2, the core 200 may include laminate skins 250. The laminate skins 250 may be modular. The laminate skins 250 may be arranged into various configurations prior to launch. For example, the laminate skins 250 may be arranged such that the strongest laminate skins 250 are interposed between the internal beams 220 and end rings 210 prior to launch. This configuration may prevent the buckling of the core 200 due to the compression from the soft goods layer and the bladder prior to launch and during launch. Additionally, the laminate skins 250 may be arranged into various configurations following launch. For example, the laminate skins 250 may be configured to support various mission activities such as transporting cargo and personnel in, out, and through the core 200. The laminate skins 250 may include cutouts to allow cargo and personnel to be transported in and around the core 200.

The laminate skins 250 may fasten to the internal beams 220, internal rings 230, and the end rings 210 to form an enclosed shell around the core 200. The internal rings 230 may also create a frame to which the laminate skins 250 may attach. The laminate skins 250 stabilize the internal beams 220 for structural support, especially for pre-launch activities. Additionally, the laminate skins 250 may enhance the maneuverability of cargo within the space habitat. The laminate skins 250 include laterally and vertically oriented cutouts to enhance the maneuverability of cargo within the habitat. Additionally, the laminate skins 250 may support the ducting and framing of a ventilation system.

The core 200 may include a mounting flange. The mounting flange may be located at the end rings 210 of the core 200. The bladder and the soft goods layer may couple to the mounting flange. The mounting flange may be a flat annular ring whose inside diameter clears the outside diameter of the core 200. The mounting flange may include a shear lip that the bladder and the soft goods layer are configured to attach to with a bracket.

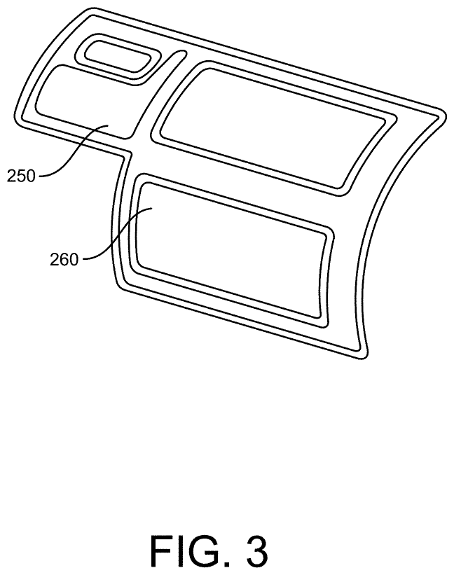

FIG. 3 depicts an example of a diagram representative of a laminate skin for the core 200 of the space habitat. The laminate skins 250 may be modular components that are configured to be assembled in a variety of configurations prior to launch and following the launch. The laminate skins 250 may have a curved contour so as to create an enclosed shell around the core 200.

The laminate skins 250 may have the shape of a parallelogram, a square, or a rectangle. The laminate skins 250 may have right angles. Additionally, and or alternatively, the laminate skins 250 may include an L-shaped configuration. For example, the laminate skins 250 may have one larger rectangular portion adjoined to a smaller square portion. The laminate skins 250 may be curved to overlap an internal beam. The laminate skins 250 may go on the outside surface of the internal beams 220. The laminate skins 250 may connect to the end ring on one end and an internal ring on the other end. The laminate skins 250 may overlap one or more internal rings 230. The laminate skins 250 may overlap an internal beam at an outside portion of the internal beam. Additionally, and/or alternatively, the laminate skins 250 may be configured to fit between an internal beam.

The laminate skins 250 may include a cutout 260 to facilitate pathways through the space habitat. For example, the laminate skins 250 may be configured to have large cutouts to allow the passage of humans and cargo. The larger cutout may extend from one internal beam to the next internal beam. The larger cutout may extend from an internal ring to the end ring. The larger cutouts may enable wide, panoramic passageways in the space habitat. The laminate skins 250 may have a smaller cutout. The smaller cutout may facilitate connection to an equipment bay or subsystem 710 attached to the laminate skin. In another example, the smaller cutouts may be configured to support ventilation and ducting in the core 200.

With reference to FIG. 3, the laminate skins 250 may be modular. The laminate skins 250 may be arranged into various configurations prior to launch. For example, the laminate skins 250 may be arranged such that the strongest laminate skins 250 are interposed between the internal beams 220 and end rings 210 prior to launch. In another example, the laminate skins 250 may be arranged near the end ring prior to launch. The laminate skins 250 may be aligned with shear panels for additional support to prevent the laminate skins 250 from buckling. This configuration may prevent the buckling of the core 200 due to the compression from the soft goods layer and the bladder prior to launch and during launch. Additionally, the laminate skins 250 may be arranged into various configurations following launch. For example, the laminate skins 250 may be configured to support various mission activities such as transporting cargo and personnel in, out, and through the core 200. The laminate skins 250 may include a cutout 260 to allow cargo and personnel to be transported in and around the core 200.

The laminate skins 250 may be coupled to the internal beams 220, internal rings 230, and the end rings 210 that form an enclosed shell around the core 200. The internal rings 230 may also create a frame to which the laminate skins 250 may attach. The laminate skins 250 stabilize the internal beams 220 for structural support, especially for pre-launch activities. Additionally, the laminate skins 250 may enhance the maneuverability of cargo within the space habitat. The laminate skins 250 include laterally and vertically oriented cutouts to enhance the maneuverability of cargo within the habitat. Additionally, the laminate skins 250 may support the ducting and framing of a ventilation system.

Some larger cutouts may be used to interface with subsystems. The larger cutouts may retain a subsystem on the outside portion of the core 200. The larger cutout may include a lip to retain the equipment bay on the outside portion of the core 200. Additionally, and/or alternatively, a pin may be pulled to remove the subsystem from the cutout 260 of the laminate skin. The cutout 260 for the subsystem may be wider than it is taller. In some embodiments, a single laminate skin may include two cutouts for subsystems. In some embodiments, ten cutouts may be implemented for subsystems across the core 200.

The cutouts may create various passageways throughout the space habitat. The width of the cutout 260 may support the ingress and the egress of wider loads between the core 200 and the rest of the space habitat. The width of the cutout 260 may allow objects to be more easily angled while inside the core 200 in order to insert them through the cutout 260. In some embodiments, the cutout 260 may be rounded on the sides to maximize support of the core 200 and to maximize the space through which loads may enter and exit the core 200.

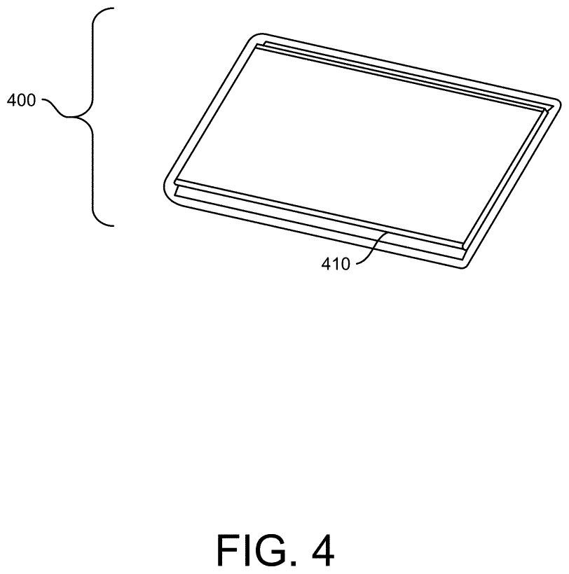

FIG. 4 depicts an example of a diagram representative of a shear panel 400 for the core 200 of a space habitat. The shear panels 400 may reinforce the core 200 to support a lateral load on the core 200. The shear panels 400 may counter the effects of the lateral load on the core 200 prior to launching the space habitat. The lateral load on the core 200 may include the bladder and the soft goods layer. The lateral load on the core 200 may include equipment and tension from the bladder and the soft goods layer after the launch phase. The shear panels 400 may change its mode of use to support different mission activities.

In a post-launch configuration, the shear panels may be configured together to create a pathway within the core 200. Additionally, the shear panels 400 may be configured together to create a work surface within the core 200 or the space habitat. Additionally, the shear panels 400 may be configured to create partitions within the core 200 or reinforce the structural integrity of the core 200 following launch. The shear panels 400 may be used for paneling, prevent foreign object debris, and protection for impact.

The shear panels 400 may include a lip. The lip 410 of the shear panels 400 may be configured to fit with the I-beam shape of the internal beam. For example, the lip 410 of the shear panels 400 may be configured to extend over the top surface of the I-beam. The lip may overlap with the top surface of the I-beam of the internal beam to support the shear panels 400. In another configuration, the shear panels 400 may be configured to be inserted into an upper protrusion of the I-beam of the internal beam. As such, the shear panels 400 may include a slot with a gap through which the upper protrusion of the I-beam may be inserted. In some embodiments, the shear panels 400 may include a lip at the lateral edges of the top surface and the bottom surface of the shear panels 400.

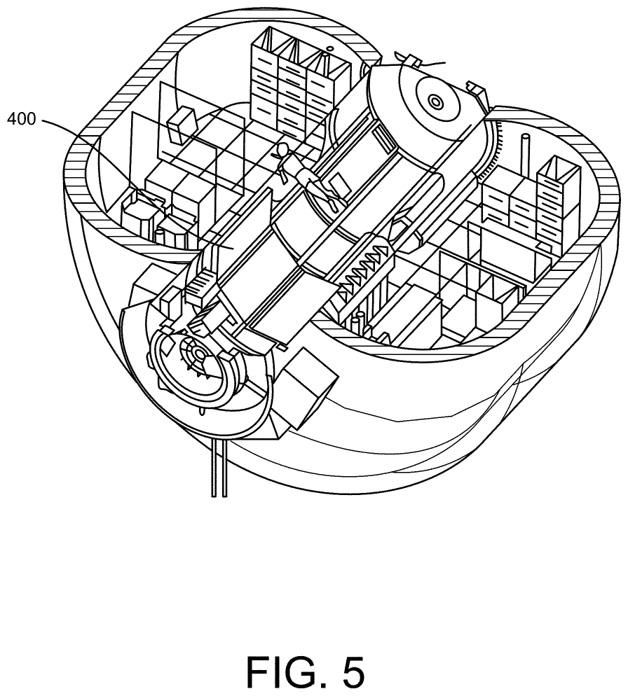

FIG. 5 depicts an example of a diagram representative of a cross-section of a core 200 configuration within the space habitat. Prior to launch, the shear panels 400 and the laminate skins 250 may be arranged in different configurations to support the core 200. For example, the shear panels 400 may be configured to support the core 200 as the bladder and the soft goods create a pushing strain against the core 200 prior.

Prior to launch, the shear panels 400 may be arranged near an end ring in the core 200. The shear panels 400 may be arranged between each internal beam near the end ring. The shear panels 400 may be arranged between the same end ring and internal ring in a circular configuration. The shear panels 400 may reinforce the structure of the core 200 to prevent buckling prior to launch and during launch. For different payload configurations, the shear panels 400 may be placed in different locations depending on the mode of use for the pre-launch configuration.

The laminate skins 250 may be arranged into various configurations prior to launch. For example, the laminate skins 250 may be arranged such that the strongest laminate skins 250 are interposed between the internal beams 220 and end rings 210 prior to launch. This configuration prevents the buckling of the core 200 from the compression from soft goods and the bladder prior to launch and during launch.

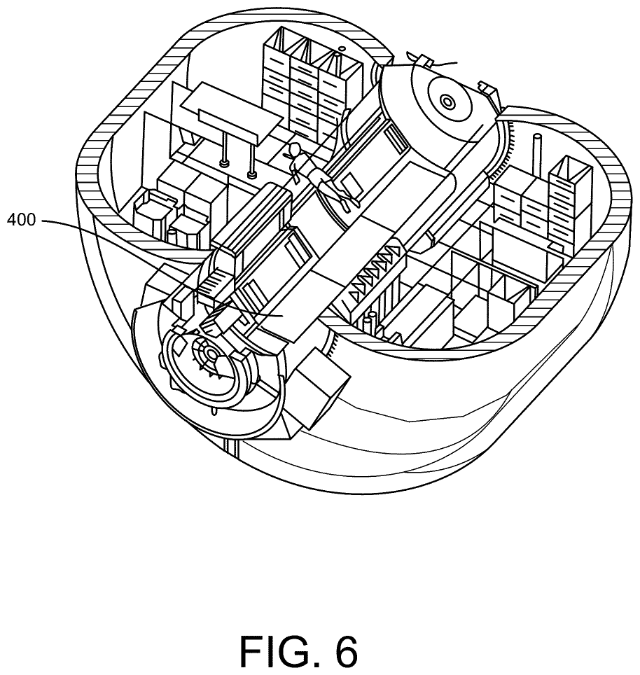

FIG. 6 depicts another example of a diagram representative of another cross-section of a core 200 configuration within the space habitat having a corridor and a table. After launch, the shear panels 400 and the laminate skins 250 may be arranged in different configurations to support the core 200.

After launch, the shear panels 400 may be arranged in different configurations inside the core 200 and outside the core 200. The shear panels 400 may be configured to be removed from the internal beams 220 near the end ring to support mission activities. For example, the shear panels 400 may be arranged to create a corridor along the base portion of the core 200. The shear panels 400 may be arranged to create a tabletop surface inside of the space habitat outside of the core 200. The shear panels 400 may be arranged to move equipment in and out of the core 200. For example, the shear panels 400 may be arranged to allow cargo to be stored below the paneling of the space habitat. The shear panels 400 may be arranged to create a partition between a top floor of the space habitat and a bottom floor of the space habitat.

Additionally, the laminate skins 250 may be arranged into various configurations following launch. For example, the laminate skins 250 may be configured to support various mission activities such as transporting cargo and personnel in, out, and through the core 200. The laminate skins 250 may include the cutout 260 to allow cargo and personnel to be transported in and around the core 200.

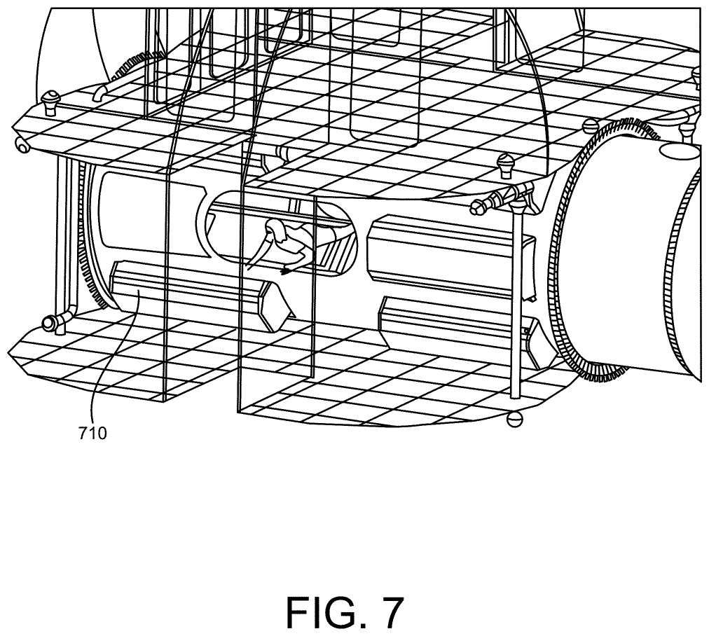

FIG. 7 depicts an example of a diagram representative of a core 200 configuration within the space habitat with two floors.

The space habitat may include two floors. A first floor may be aligned with the core 200 and include a cutout 260 in a skin laminate of the core 200 for ingress and egress of the core 200. The first floor may include partitions between different portions of the first floor. For example, the first floor may include a partition for a ventilation channel that extends vertically between the first floor and the second floor. In some embodiments, persons or cargo may pass between the ventilation channel that extends vertically between the first floor and the second floor. The first floor may include secondary structures proximate to the edges of the paneling to reinforce the structure and spacing of the paneling or flooring. The first floor may also include equipment bays or a subsystem 710. The subsystem 710 may include an astro-garden that includes plants to be grown in the space habitat. Another subsystem 710 may include an air revitalization subsystem or a slotted style experiment rack. The subsystem 710 may be selectively removed from the side of the core 200. The subsystem 710 may be positioned near the middle of the core 200. The subsystem 710 may be removed and become serviced throughout the life of the space habitat. The subsystem 710 may be configured to match the form factor of the cutout 260 of the laminate skins 250.

The second floor may be above the core 200 and include a flooring partition between the first floor and the second floor. The second floor may include various partitions to separate the second floor into separate rooms. For example, a partition may separate the second floor into at least two different quarters for storing the personal belongings of the astronauts. In another example, the partition may separate the second floor into at least two laboratories. The partition may comprise the shear panels 400.

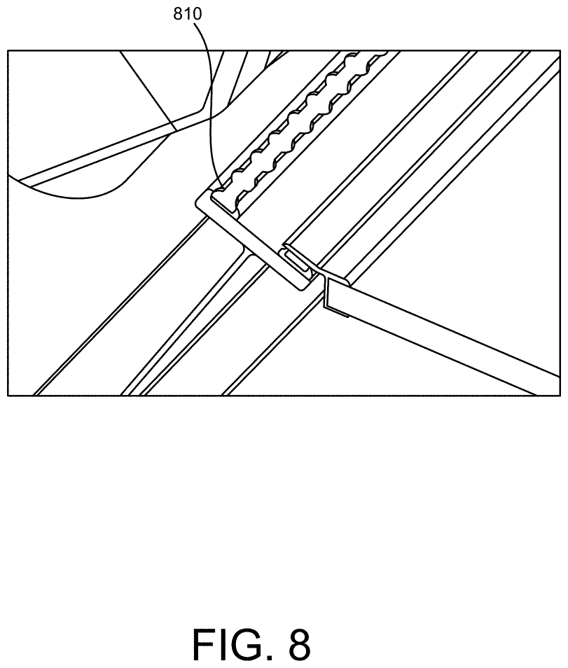

FIG. 8 depicts another example of a diagram representative of a mounting track 810 extending along an internal beam of the core 200. The internal beams 220 may support a trolley or mounting track system upon which robotics may operate. For example, a robot may receive cargo at one end of the core 200 and transport the cargo to the other end of the core 200 along the internal beam. In another example, a robot may tend to a garden in a pallet next to an internal beam.

The mounting track 810 may run the length of the core 200. The mounting track 810 may include a bar with an aperture. The aperture may be configured to receive a wheel to fit inside the bar and to run the length of the mounting track 810. The mounting track 810 may include small recesses to enable the device to lock into place while traversing the core 200. The small recesses may be included on both sides of the mounting track 810 along the length of the aperture. The recesses on both sides of the mounting track 810 may be aligned with one another. The mounting track 810 may include additional tracks on other internal beams 220 that run parallel to the mounting track 810. The devices (e.g., robots) that run along the mounting track 810 may be configured to transport loads in and out of the core 200.

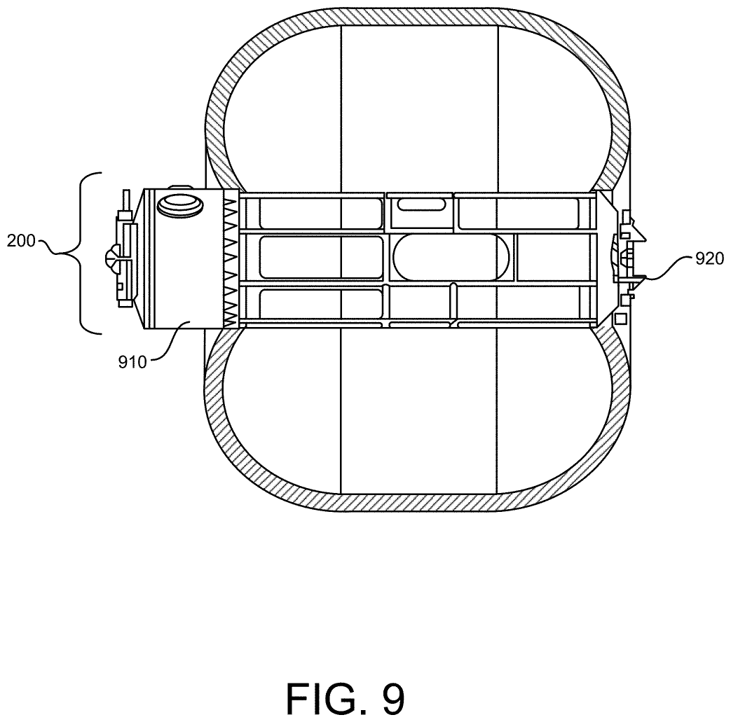

FIG. 9 depicts an example of a diagram representative of a core 200 with a vestibule 910 and a pressure bulkhead 920. The end rings 210 may be configured to connect to a vestibule 910 or a pressure bulkhead 920. The vestibule 910 may extend beyond the edges of the space habitat.

The vestibule 910 may be a volume of the space habitat. The vestibule 910 may be configured to couple to a payload external to the space habitat. The vestibule 910 may be an interface for docking to an external spacecraft. For example, the vestibule 910 may allow the core 200 to dock to another spacecraft or space vessel. The vestibule 910 may be configured to load and unload cargo between the core 200 and the external spacecraft.

The vestibule 910 may be configured to house subsystems. For example, the vestibule 910 may house a solar panel. The vestibule 910 may include an external surface for connecting external components to the module. For example, the vestibule 910 may connect to a robotic arm that manipulates objects in space. In another example, the vestibule 910 may include a launch vehicle interface that houses a small space vessel. The vestibule 910 may be a separate pressurized volume that includes an airlock with a pressure barrier between the core 200 and the vestibule 910.

The core 200 may include a pressure bulkhead 920 at one end of the core 200. The core 200 may include the pressure bulkhead 920 at the opposite side from the vestibule 910. The pressure bulkhead 920 may be a rigid structure. The pressure bulkhead 920 may take pressure loads. For example, the pressure bulkhead 920 may interface with the soft goods to the core 200 to reinforce the structural integrity of the core 200. The pressure bulkhead 920 may augment the hoop loading of the soft goods layer.

The pressure bulkhead 920 may serve as an adapter or mating system at the end of the core 200. The pressure bulkhead 920 may serve as a payload adapter. For example, the pressure bulkhead 920 may include another space vessel at the end of the core 200, such as a tug or service vehicle that may be released from the core 200 following launch.

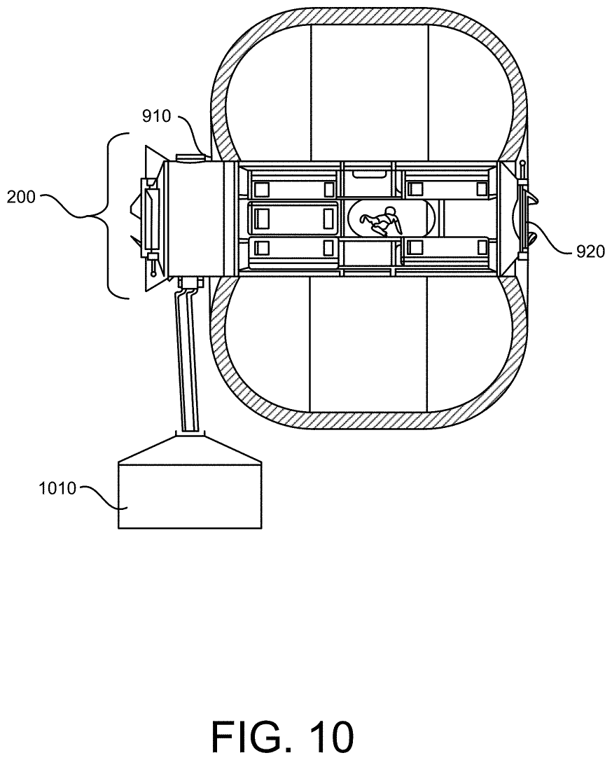

FIG. 10 depicts an example of a diagram representative of a core 200 attached to an external space structure 1010. The core 200 may include a vestibule 910. The vestibule 910 may be connected to either side of the core 200 110. The vestibule 910 may be an interface for connecting to an external space structure 1010. The vestibule 910 may be a transition chamber between the space habitat and the external space structure 1010. Either side of the vestibule 910 may include a selectively removable air pressure door configured to seal off pressure between the vestibule 910 and the external space structure 1010.

The terminology used herein is for the purpose of describing particular embodiments only and is not intended to be limiting of the embodiments. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” may be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The many features and advantages of the disclosure are apparent from the detailed specification, and thus, it is intended by the appended claims to cover all such features and advantages of the disclosure which fall within the true spirit and scope of the disclosure. Further, since numerous modifications and variations will readily occur to those skilled in the art, it is not desired to limit the disclosure to the exact construction and operation illustrated and described, and accordingly, all suitable modifications and equivalents may be resorted to, falling within the scope of the disclosure

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The implementations set forth in the foregoing description do not represent all implementations consistent with the subject matter described herein. Instead, they are merely some examples consistent with aspects related to the described subject matter. Although a few variations have been described in detail herein, other modifications or additions are possible. In particular, further features and/or variations can be provided in addition to those set forth herein. For example, the implementations described above can be directed to various combinations and sub-combinations of the disclosed features and/or combinations and sub-combinations of one or more features further to those disclosed herein. In addition, the logic flows depicted in the accompanying figures and/or described herein do not necessarily require the particular order shown, or sequential order, to achieve desirable results. The scope of the following claims may include other implementations or embodiments.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

While the foregoing is directed to implementations of the present disclosure, other and further implementations of the disclosure may be devised without departing from the basic scope thereof, and the scope thereof is determined by the claims that follow.

What is claimed is:

1. A core for a space habitat, the core comprising:
a plurality of internal beams extending a length of the core;
a plurality of end rings at a first end of the core and a second end of the core, the plurality of end rings spaced the length of the core; and
an internal ring coupled to the internal beams between the first end and the second end.

2. The core of claim 1, the core further comprising:
a plurality of modular laminate skins configured to couple to the plurality of internal beams, the plurality of end rings, and the internal ring,
wherein the plurality of modular laminate skins, the plurality of internal beams, the plurality of end rings, and the internal ring form an outer shell of the core.

3. The core of claim 2, wherein at least one modular laminate skin of the plurality of modular laminate skins has a cutout, and wherein the plurality of modular laminate skins is fastened to at least one of the plurality of internal beams, the internal ring, and the plurality of end rings.

4. The core of claim 3, wherein the cutout is sized to support a passage of humans and cargo through the space habitat.

5. The core of claim 1, the core further comprising:
a plurality of modular shear panels configured to mount to the internal beams,
wherein the plurality of modular shear panels may be adjacent to one end ring of the plurality of end rings in a pre-launch configuration.

6. The core of claim 5, wherein the plurality of modular shear panels includes a lip, the lip configured to overlap an internal beam of the plurality of internal beams for supporting the plurality of modular shear panels.

7. The core of claim 1, the core further comprising:
a mounting track extending the length of the core along a first internal beam of the plurality of internal beams,
wherein the mounting track includes a bar with an aperture.

8. The core of claim 7, wherein the aperture is configured to receive a wheel from a device configured to slide along the mounting track.

9. The core of claim 7, wherein the aperture includes recesses aligned along both sides of the mounting track, the recesses configured to enable a device configured to slide along the mounting track to lock in place.

10. A method for reconfiguring shear panels in a space habitat, the method comprising:
securing the shear panels near an end ring of a core prior to a launch of the space habitat, the shear panels being interposed between a plurality of internal beams extending from the end ring; and
securing the shear panels along a different portion of the core based on launching the space habitat.

11. The method of claim 10, wherein the different portion includes a corridor extending a length of the core.

12. The method of claim 10, wherein the shear panels are placed proximate to the end ring of the core to prevent buckling of the core due to compressive forces from a bladder and a soft goods layer wrapped around the core.

13. The method of claim 10, wherein the different portion includes at least one of a work surface or a partition located inside the space habitat.

14. A space habitat system comprising:
a core for a space habitat;
a vestibule coupled to a first end of the core, the vestibule forming a volume of the space habitat; and
a pressurization bulkhead coupled to a second end of the core, the pressurization bulkhead being a rigid structure configured to take a pressure load.

15. The space habitat system of claim 14, wherein the vestibule includes an airlock with a pressure barrier between the core and the vestibule.

16. The space habitat system of claim 14, wherein the vestibule includes an interface for docking to an external spacecraft.

17. The space habitat system of claim 14, wherein the vestibule is coupled to a robotic arm that manipulates objects in space.

18. The space habitat system of claim 14, wherein the pressure bulkhead is further configured to be a payload adapter.

19. The space habitat system of claim 14, wherein the core further comprises:
a plurality of internal beams extending a length of the core;
a plurality of end rings at the first end of the core and the second end of the core, the plurality of end rings spaced the length of the core; and
an internal ring coupled to the internal beams between the first end and the second end.

20. The space habitat system of claim 19, wherein the core further comprises:
a plurality of modular laminate skins configured to couple to the plurality of internal beams, the plurality of end rings, and the internal ring,
wherein the plurality of modular laminate skins, the plurality of internal beams, the plurality of end rings, and the internal ring form an outer shell of the core.
